(19) United States
(12) Patent Application Publication
(10) Pub. No.: US 2016/0225157 A1
(43) Pub. Date: Aug. 4, 2016

(54) REMAPPING A DEPTH MAP FOR 3D VIEWING

(71) Applicant: KONINKLIJKE PHILIPS N.V., Eindhoven (NL)

(72) Inventors: ZHAORUI YUAN, EINDHOVEN (NL); WILHELMUS HENDRIKUS ALFONSUS BRULS, EINDHOVEN (NL); WIEBE DEHAAN, EINDHOVEN (NL)

(21) Appl. No.: 15/028,808

(22) PCT Filed: Oct. 14, 2014
(86) PCT No.: PCT/EP2014/071948

§ 371 Date: Apr. 12, 2016

(30) Foreign Application Priority Data
Oct. 14, 2013 (EP) 13188429.8

(51) Int. Cl. G06T 7/00; G06T 7/60; G06T 17/10; G06T 15/00; G06T 15/20

(52) U.S. Cl. CPC G06T 7/0075; G06T 15/005; G06T 15/20; G06T 7/0085; G06T 17/10; G06T 7/60; G06T 2200/04

(57) ABSTRACT

Image processing device (100) arranged for remapping a depth map (101) is disclosed. A 3D image comprises the depth map and a content image. The depth map has depth pixels in a 2D array. Each depth pixel has a depth value (203) and a location (201, 202). The remapping comprises a global remapping function (122). The image processing device comprises a processing unit (199) comprising: a selection function (110) for selecting depth pixels (112) that correspond to at least one object in the three-dimensional image using selection criteria based on at least location and depth value; a determining function (120) for determining a local remapping function (121) for remapping the object; and a mapping function (130) for remapping the depth map using the local remapping function for remapping the selected depth pixels and using the global remapping function for other depth pixels. The object is selected using selection criteria provided via metadata coupled to the 3D image.

### FIELD OF THE INVENTION

The invention relates to remapping of a depth map that corresponds to a two-dimensional (2D) content image. The 2D image and the depth map form the basis for rendering a three-dimensional (3D) image that is to be viewed on a 3D display. The remapping maps the depth map from an input depth range to an output depth range of the 3D display.

### BACKGROUND OF THE INVENTION

Literature paper ‘Disparity remapping to ameliorate visual comfort of stereoscopic video’ (Sohn et al, Proc. SPIE 8648, Stereoscopic Displays and Applications XXIV, 86480Y) describes a method for remapping of a disparity map. The disparity map is part of a three-dimensional (3D) image that also comprises a two-dimensional (2D) image corresponding to the disparity map. The disparity map is remapped into a new disparity map such that the 3D image (based on the new disparity map) can be viewed on a 3D display. The remapping is established as follows. First, the method establishes a global remapping curve for mapping the disparity map from an input disparity range to an output disparity range (of the 3D display). Second, the method identifies local salient features based on disparity transitions that cause visual discomfort when viewing the 3D image on the 3D display. The global remapping curve is therefore adapted to the local salient features in order to reduce said visual discomfort. The disparity map is then remapped according to the adapted global remapping curve.

US2012/0314933 discloses image processing that includes estimating an attention region which is estimated as a user paying attention thereto on a stereoscopic image, detecting a parallax of the stereoscopic image and generating a parallax map indicating a parallax of each region of the stereoscopic image, setting conversion characteristics for correcting a parallax of the stereoscopic image based on the attention region and the parallax map, and correcting the parallax map based on the conversion characteristics. Different conversion functions may be used for the attention region and the background.

US2013/0141422 describes a system for altering a property associated with a portion of a three dimensional stereoscopic image. The method includes determining that a portion of a virtual object in a three dimensional image resides at a predetermined position along a first axis relative to the display based on a difference between a left eye image of the portion of the virtual object and a right eye image of the portion of the virtual object. The first axis is perpendicular to a plane of the display.

WO2009/034519 describes receiving depth related information for image data, including receiving metadata relating to a mapping function used in generation of depth-related information.

US2012/0306866 describes 3D-image conversion for adjusting depth information. The conversion includes generating depth information with regard to an input image; detecting an object having parallax exceeding a preset range; and adjusting depth information of the object by adjusting the parallax of the detected object to be within a preset range. Metadata, for example genre or viewing age, may be analyzed in order to adjust generated depth information to be within a predetermined range.

### SUMMARY OF THE INVENTION

A disadvantage of the prior art is that the adaptability of the global disparity remapping (or ‘retargeting’) to the local features is limited, because all adaptations to the local features need to be accommodated by the same (adapted) global remapping. It is an aim of the invention to overcome the disadvantage of the prior-art by providing a depth remapping that accurately selects and adapts an object in the image without adapting the depth remapping in other parts of the image.

An image processing device is disclosed, arranged for remapping a depth map of a three-dimensional image, the three-dimensional image comprising the depth map and a two-dimensional content image, the depth map having depth pixels configured in a two-dimensional array at locations corresponding to locations of image pixels in the content image, each of the depth pixels having a depth value, the remapping comprising a global remapping function for mapping of depth values of the depth map to new depth values of the depth map, the image processing device comprising a receiving unit for receiving a signal comprising the three-dimensional image and metadata coupled to the three-dimensional image,

the metadata comprising selection criteria based on at least location and depth value for selecting depth pixels corresponding to at least one object in the three-dimensional image, and a processing unit comprising a selection function configured for retrieving, from the metadata, the selection criteria and selecting depth pixels that correspond to at least one object in the three-dimensional image using the selection criteria; a determining function configured for determining a local remapping function for mapping depth values of the selected depth pixels to new depth values; and a mapping function configured for remapping the depth map using the local remapping function for remapping the selected depth pixels and using the global remapping function for depth pixels other than the selected depth pixels.

The three-dimensional (3D) image includes a depth map and a corresponding content image. The depth map comprises depth pixels in a 2D array at respective locations along X and Y axes, each depth pixel having a depth value. Each pixel of the depth map corresponds to a pixel at a corresponding location in the content image. Such a 3D image format is commonly known as ‘image-plus-depth’ or ‘2D+Z’.

Remapping the depth map implies mapping of depth values of respective depth pixels of the depth map to respective new depth values. The remapping comprises at least a global remapping function for remapping the depth map.

The selection function is configured for selecting depth pixels that correspond to an object in the three-dimensional image, using selecting criteria at least based on location and depth value. For example, the selection criteria comprise boundaries in depth and location that include depth pixels corresponding to a foreground object: the selection function selects depth pixels corresponding to the foreground object by selecting the depth pixels residing within the boundaries. Selecting the object based on location and depth value enables accurate selection of the object, such that a high percentage of depth pixels corresponds to that object while selecting a low percentage of depth pixels not corresponding to that object.

Optionally, the selection function comprises an automated process for determining (foreground) objects in the 3D image.

The determining function is configured for determining a local remapping function for remapping the selected depth pixels. The local remapping function is a different remapping function than the global remapping function.

Optionally, the determining function is configured for retrieving the local remapping function from metadata coupled to the 3D image. Optionally, the determining function comprises an automated process for determining the local remapping function, such that depth contrast between the object and another object and/or the background improves.

The remapping function is configured for remapping the depth map using both the local remapping function and the global remapping function. The local remapping function is used for remapping the selected depth pixels, whereas the global remapping function is used for remapping the remaining (not selected) depth pixels.

A method is disclosed for remapping a depth map of a three-dimensional image, the three-dimensional image comprising the depth map and a two-dimensional content image, the depth map having depth pixels configured in a two-dimensional array at locations corresponding to locations of image pixels in the content image, each of the depth pixels having a depth value, the remapping comprising a global remapping function for mapping of depth values of the depth map to new depth values, the method comprising receiving a signal comprising the three-dimensional image and metadata coupled to the three-dimensional image, the metadata comprising selection criteria based on at least location and depth value for selecting depth pixels corresponding to at least one object in the three-dimensional image, retrieving, from the metadata, the selection criteria, selecting depth pixels corresponding to an object in the three-dimensional image, using the selection criteria; and determining a local remapping function for mapping depth values of the selected depth pixels to new depth values; and remapping the depth map using the local remapping function for remapping the selected depth pixels and using the global remapping function for depth pixels other than the selected depth pixels.

A signal is disclosed for use in the image processing device as described above for remapping a depth map, the signal comprising a three-dimensional image and metadata coupled to the three-dimensional image, the three-dimensional image comprising the depth map and a content image, the depth map having depth pixels configured in a two-dimensional array, each of the depth pixels having a depth value and having a location in the two dimensional array corresponding to a location in the content image, the metadata comprising the selection criteria based on at least location and depth value for selecting the depth pixels corresponding to at least one object in the three-dimensional image for mapping depth values of the selected depth pixels to new depth values.

An image encoding method is disclosed for generating metadata for use in the above signal, the method comprising the steps of generating metadata comprising selection criteria based on at least location and depth value for selecting depth pixels corresponding to at least one object in a three-dimensional image for mapping depth values of the selected depth pixels to new depth values, and coupling the metadata to the three-dimensional image.

The invention does not have the said disadvantage of the prior art because the metadata enables accurately selecting depth pixels corresponding to the object by using both location and depth value. The accurate selection of the object consequently enables a local remapping to be applied accurately to the object while a global remapping is being maintained for other parts of the image.

Note that the term ‘accurately’ in this context refers to selecting a high percentage of depth pixels corresponding to that object while selecting a low percentage of depth pixels not corresponding to that object. For example, the high percentage refers to 95-100%, and the low percentage refers to 0-5%. The effect of the invention is that the depth remapping adapts accurately to an (local) object in the 3D image while maintaining a global remapping for other parts of the 3D image.

### BRIEF DESCRIPTION OF THE DRAWINGS

These and other aspects of the invention are apparent from and will be elucidated with reference to the embodiments described hereinafter.

In the drawings,

FIG. 1 illustrates an image processing device for remapping a depth map,

FIG. 2a illustrates a depth map comprising two foreground objects and a background

FIG. 2b illustrates depth profiles for the two foreground objects,

FIG. 3a illustrates selection of a complex object using multiple shapes,

FIG. 3b illustrates selection of an object consisting of multiple smaller disconnected objects, and

FIG. 4 illustrates a global remapping function and two local remapping functions.

It should be noted that items that have the same reference numbers in different figures, have the same structural features and the same functions. Where the function and/or structure of such an item has been explained, there is no necessity for repeated explanation thereof in the detailed description

### DETAILED DESCRIPTION OF THE INVENTION

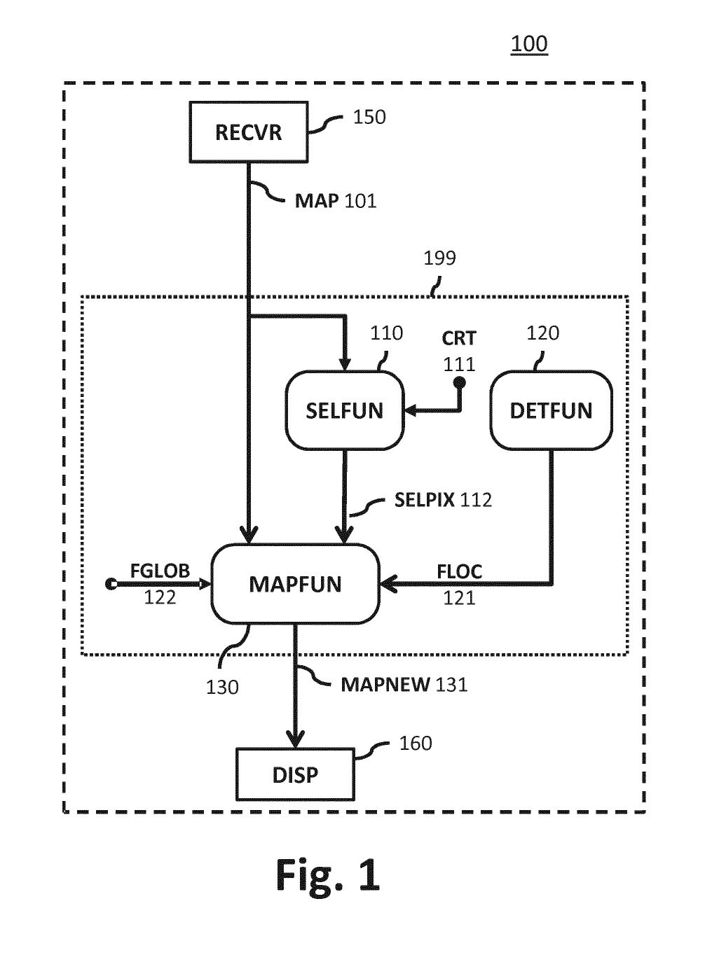

FIG. 1 illustrates an image processing device 100 for remapping a depth map MAP 101. The depth map MAP comprises a two-dimensional (2D) array of depth pixels, wherein each of the depth pixels has a depth value and a location in the 2D array. The image processing device 100 comprises a processing unit 199 that is arranged for performing several functions 110, 120 and 130. A selection function SELFUN 110 selects depth pixels SELPIX 112 in the depth map MAP, using selection criteria CRT 111. A determining function DETFUN 120 then determines a local remapping function FLOC 121 for remapping the selected depth pixels SELPIX. A mapping function MAPFUN 130 then remaps the depth map MAP by (1) remapping the selected depth pixels SELPIX using the local remapping function FLOC and by (2) remapping other pixels than the selected depth pixels SELPIX using a global remapping function FGLOB 122. The output of the remapping function MAPFUN is a new depth map MAPNEW 131, having the same format as input depth map MAP.

Note that the term ‘remapping a depth map’ means that depth values of the depth map are mapped to respective new depth values.

The depth map MAP is formatted as said 2D array of depth pixels. The depth map MAP comprises depth pixels and is coupled to a (2D) content image comprising content pixels representing content. For example, the content image shows a natural scene and is a photograph or is a video frame of a movie. The combination of the content image and the depth map 101 constitute a three-dimensional (3D) image format that is commonly known as ‘2D+Z’ or ‘2D+depth’.

A depth pixel at a location in the 2D array corresponds to a pixel at a corresponding location in the (2D) content image. If the depth map has the same resolution as the content image, then a content pixel at a certain location in the content image corresponds to a depth pixel at the same certain location in the depth map. If the depth map has a different resolution than the content image, then the content pixel at the location in the content image corresponds to a depth pixel at the same location in the scaled depth map, which is the result of scaling the depth map to the resolution of the content image. Therefore, in the context of this document, referring to a location (or region) in the content image is equivalent to a location in the depth map MAP.

Optionally, the image processing device 100 includes a receiving unit RECVR 150 for receiving a signal comprising a 3D image and metadata to provide the depth map MAP to the processing unit 199. The receiving unit RECVR may receive the 3D image having a depth map and the metadata comprising selection criteria, e.g. from an optical disc, and provide the depth map and the selection critria to the processing unit 199. Having the receiving unit RECVR, the image processing device 100 may act as an optical disc unit.

Optionally, the image processing device 100 includes a display DISP 160 that receives the remapped depth map MAPNEW from the processing unit 199 and renders the 3D image for viewing on the display DISP, based on the remapped depth map MAPNEW. Having the display DISP, the image processing 100 may act as a 3D TV.

The selection function SELFUN selects, from the depth map MAP, depth pixels that meet the selection criteria CRT. Selection function SELFUN obtains the selection criteria CRT, for example, from metadata coupled to the 3D image, and selects the depth pixels accordingly. The selection criteria CRT are based on (at least) depth and location.

The selected (depth) pixels typically correspond to an object in the 3D image. An object is naturally confined to a region of the 3D image. For example, the object corresponds to a floating ball being near the camera that captured the 3D image. When viewing the 3D image on a 3D display, the ball is in the foreground and floats in front of the rest of the scene in the 3D image. The ball is confined not only to the region in the depth map MAP, but is also confined to a limited depth range. The ball can thus be selected using selection criteria that define a 3D bounding box having three sides: (1) a first side along to a horizontal dimension of the 2D location, (2) a second side along a vertical dimension of the 2D location and (3) a third side along a depth dimension, respectively. Effectively, the 3D bounding box is defined in a 3D mathematical space being a location-depth' space. Selecting the ball is done by selecting depth pixels residing inside the bounding box. The advantage of selecting an object, like the ball, on the basis of both depth and location is further explained in what follows.

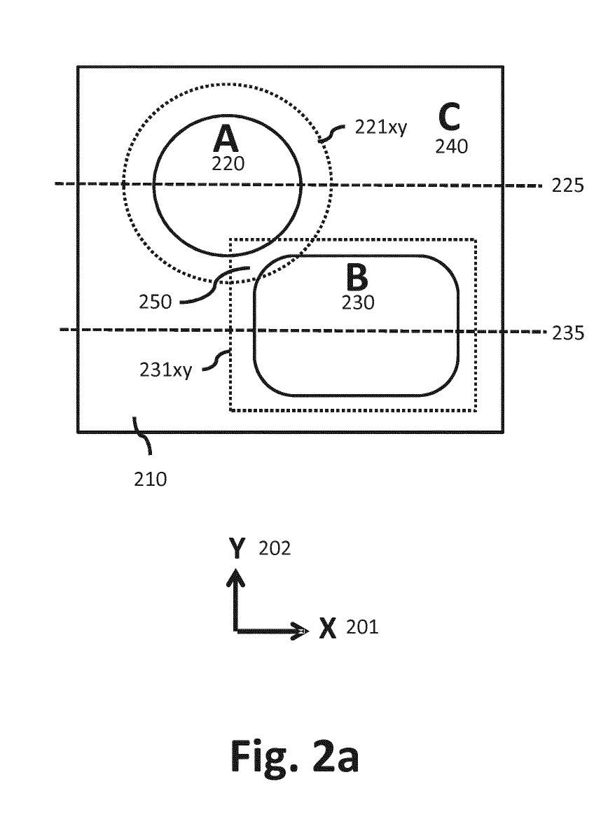

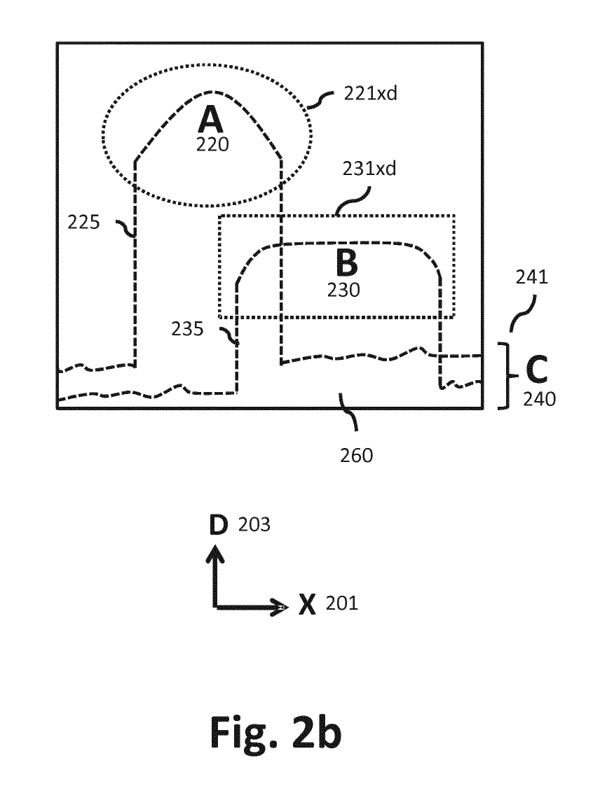

FIG. 2a illustrates a depth map 210 comprising two foreground objects, A220 and B 230, and a background C 240. The depth map 210 is a 2D array with a horizontal coordinate X 201 and a vertical coordinate Y 202. Each depth pixel in the depth map 201 thus has a depth value and a location (X,Y).

Foreground object A is surrounded by a circular boundary 221xy, whereas foreground object B is surrounded by a bounding box 231. Depth pixels corresponding to foreground object A may be selected by selecting depth pixels that reside within the circular boundary 221xy. However, such a selection will be inaccurate in the sense that not only depth pixels corresponding to object A will be selected, because art of the background C and the foreground object B are also included by the circle 221xy. Likewise, bounding box 231 will also be inadequate for accurately selecting depth pixels corresponding to foreground B, because bounding box 231 also includes a part of the background C and the foreground object A. Overlap area 250 is a region where (object A's) boundary 220 also includes a part of object B and where (object B's) boundary 230 also includes a part of object A. Therefore, selection criteria such as the boundaries 221xy and 231xy, which are purely based on location, are not adequate for accurately selecting objects A and B in the content image. Note that ‘accurate selection of an object’ in this context refers to selecting a high percentage of depth pixels corresponding to that object while selecting a low percentage of depth pixels not corresponding to that object. For example, the high percentage refers to 95-100%, and the low percentage refers to 0-5%.

FIG. 2b illustrates depth profiles for the two foreground objects A and B. Graph 260 has axes depth D 203 and horizontal coordinate X 201. Depth profile 225 in FIG. 2b represents a cross-section of the depth map 210 of FIG. 2a (see also dashed line 225 in FIG. 2a). The depth profile 225 includes pixels of both the object A and the background C (see indicated range 241). Likewise, depth profile 235 in FIG. 2b also represents a cross-section of the depth map 210 of FIG. 2a (see also dashed line 235 in FIG. 2a). The depth profile 235 includes pixels of both the object B and the background C.

Foreground object A is surrounded by an elliptical boundary 221xd, whereas foreground object B is surrounded by a bounding box 231xd (rectangular boundary). Depth pixels corresponding to foreground object A can be selected accurately using the elliptical boundary 221xd, because only pixels of foreground object A are included in the ellipse 221xd. Thus, by selecting depth pixels that reside inside ellipse 221xd, only depth pixels corresponding to foreground object A are selected. Likewise, depth pixels corresponding to foreground object B can be selected accurately using the bounding box 231xd, because only pixels of foreground object B are included in the bounding box 231xd. Thus, by selecting depth pixels that reside inside bounding box 231xd, only depth pixels corresponding to foreground object B are selected. Selection criteria, such as the boundaries 221xd and 231xd, which are based on both location and depth value, are thus adequate for accurately selecting an objection in the 3D image.

FIG. 2a and FIG. 2b each represent a two-dimensional view of the three-dimensional X-Y-D (XYD) space, i.e. location-depth space. Generalizing the example in the previous paragraph to

XYD space, an object is thus selected using a 3D boundary in XYD space. For accurately selecting the foreground object A, the selection criteria comprise a 3D ellipsoid. Provided that the ellipsoid includes object A in the D-Y plane (not shown) in a similar manner as in the D-X plane (as shown in FIG. 2b), then foreground object A is accurately selected by the 3D ellipsoid. The selected depth pixels exclusively include all depth pixels corresponding to object A. Likewise, for accurately selecting the foreground object B, the selection criteria comprise a 3D bounding box. Provided that the 3D bounding box includes object B in the D-Y plane (not shown) in a similar manner as in the D-X plane (as shown in FIG. 2b), then foreground object B is accurately selected by the 3D bounding box. The selected depth pixels exclusively include all depth pixels corresponding to object B. Thus, selection criteria which are based on both the 2D location and depth value, are adequate for accurately selecting an object in the 3D image.

The previous paragraphs describe an example of a general case, wherein accurate selection requires selection criteria based on both the 2D location and depth value. However, two particular cases may occur wherein accurate selection does not require the 2D location or requires only one dimension of the 2D location.

In a first particular case of foreground object A and B in FIGS. 2a-2b, selection criteria based on only depth value may actually be sufficient for accurately selecting depth pixels of object A and B, respectively, provided that objects A and B and background C are separated in depth value. (Note that FIG. 2b only shows only two cross-sections 225 and 235 of the depth map 210 of FIG. 2a, so that one cannot infer from—only—FIG. 2b that objects A and B and background C are fully separated in depth value.) This first potential case occurs when objects A and B and background C are indeed fully separated in depth value by the lower (depth) bound and the upper (depth) bound of bounding box 231xd. In that case, the background C has only depth values below said lower bound, object A has only depth values above said upper bound, and object B has only depth values in between said lower bound and said upper bound.

In a second particular case, in analogy to the first particular case, accurate selection of objects A and B requires only criteria based on depth value and one dimension (X or Y) of the location. A requirement for this second particular case would be that objects A and B and background C are separated in depth value and in one dimension (X or Y) of the 2D location.

In contrast, as explained above, it is not possible to accurately select depth pixels of object A (or B) based on only location in a typical case, wherein the boundary 221xy (or 231xy) surrounds object A (or B) with some margin (as illustrated FIG. 2a). The margin is practically necessary in order to be able to include and select all pixels corresponding to an object (which may have any shape) with a simple shape such as an ellipse. The margin of boundary 221xy around object A includes parts of background C and even object B. Typically, objects A/B and background C are not separated in depth value only, so that accurate selection requires criteria based on both depth value and location.

In summary: in the general case, accurate selection requires selection based on depth value and 2D location; in the first particular case, accurate selection requires selection based on only depth; in the second particular case, accurate selection requires selection based on depth and one dimension of the location.

Various shapes may be used for selecting an object. FIGS. 2a and 2b illustrate an ellipsoid and a rectangular bounding box. Other possible shapes include a cube, or a sphere, or a cylinder. Further possible shapes include an ellipsoid rotated such that its principal axes are not aligned with the X, Y or D axis, or, analogously, a rotated bounding box. Such shapes are parameterized by a few numbers that thus constitute the selection criteria. For example, an ellipsoid (or bounding box) is parameterized by a range in each of the X, Y and D dimensions, thus by a total of six numbers: three dimensions times two numbers (a range is defined by two numbers being a minimum value and a maximum value). Parameterizing a rotated ellipsoid (or bounding box) generally requires two additional numbers, namely two angles of rotation.

Note that, in principle, any shape being a closed volume in the XYD space may be used for selecting an object.

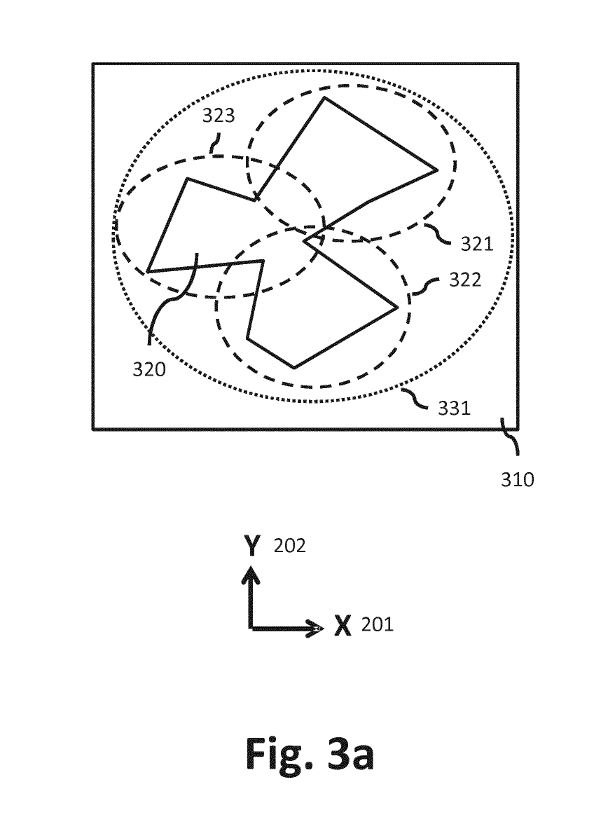

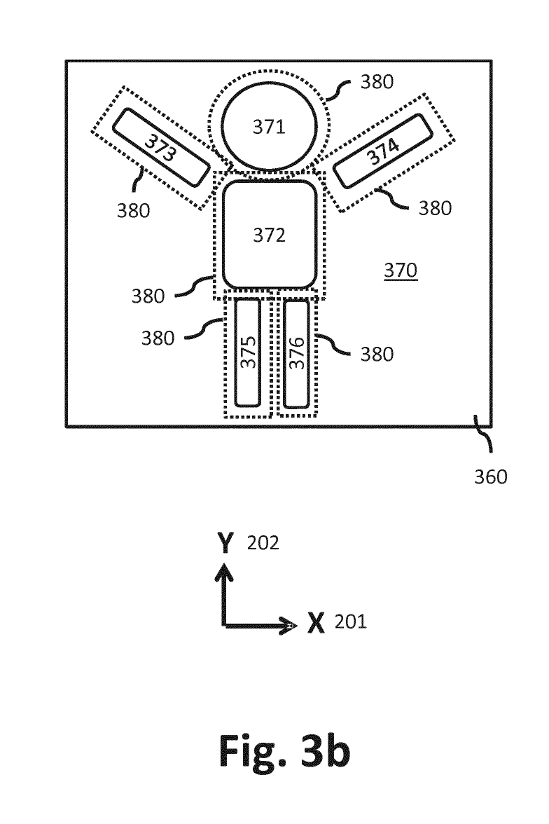

FIG. 3a illustrates selection of a complex object 320 using multiple shapes 321-323. The format of graph 310 is similar to that of graph 210 (in FIG. 2a): the axes are represented by the respective pixel coordinates X and Y. Foreground object 320 is complex in the sense that it has an irregular shape. In this example, three ellipses include the foreground object 320. Alternatively, a single large ellipse 331 is used to include object 320; however, using the three (small) ellipses 321-323 yields a tighter ‘fit’. Here, the selection criteria consist of parameters describing three (3D) ellipsoids, shown here by the two-dimensional ellipses 321-323 in the X-Y plane. Provided that three ellipsoids are sufficient to also include the foreground object 320 in the depth dimension D, accurately selecting depth pixels corresponding to foreground object 320 is done by selecting depth pixels residing inside the ellipsoids 321-323. In other words: the ellipsoids 321-323 together form a volume, the outer surface of which envelops the depth pixels corresponding to object 320, and depth pixels are selected by selecting depth pixels enveloped by said outer surface. A variant (not shown) of the example in FIG. 3a is that a mixture of different shapes is used for selecting the foreground object 320, e.g. an ellipsoid, a bounding box and a sphere.

Note that margins between an object and its selection boundaries are preferably not too ‘small but also not too large. A small margin corresponds to a ‘tight fit’ of the selection boundaries around an object, and therefore has a risk that not all depth pixels of the object are included in the boundary and may therefore not be selected. A large margin corresponds to a ‘loose fit’ of the selection boundaries around the object (e.g. ellipsoid 331) and has a risk that depth pixels of other objects or the background are included and may therefore not be selected.

FIG. 3b illustrates selection of an object 370 consisting of multiple smaller disconnected objects 371-376. Graph 360 is in the same format as the graph 310 of FIG. 3a. A puppet 370 has a head 371, a torso 372 and limbs 373-376 that are not directly connected to each other, but instead are separated by some space. Such a ‘disconnected’ object may thus be selected using multiple disconnected shapes 380, which in this case is even a mixture of different shapes. As another example, a subtitle represents a single object that consists of multiple smaller disconnected objects which are the individual characters.

Again, note that graph 360 presents a two-dimensional view and that the generalized case of FIG. 3b corresponds to selecting multiple disconnected 3D objects 371-376 in the three-dimensional XYD space using multiple three-dimensional shapes 380.

As a variant to FIG. 3b, the selection boundaries enveloping a single volume may include not only a single object but also multiple objects. In contrast, in the previous examples a single object was enveloped by a single volume consisting of one or multiple shapes. For example, in the case of FIGS. 2a and 2b, objects A and B may be selected by a single bounding box, provided that the background is not selected by the single bounding box (e.g. when depth values of the background are all higher than all depth values of object B). As another example, the multiple objects correspond to two persons playing football, being three disconnected objects in total: the first person, the second person and a ball. These three objects are related and together represent a single foreground scene. A single volume is used to envelop the three objects, and remap the depth values of the three objects using a single local remapping function, according to the invention. (Alternatively, similar to the case of FIG. 3b, each of the three objects is separately selected by a single volume (thus three volumes in total), and the depth values of the three objects are remapped using the same single local remapping function).As a further refinement, the selection function SELFUN comprises an additional selection function that filters out depth pixels of small clusters. A small cluster has a higher probability to contain noise than a large cluster. Therefore, by selecting only depth pixels corresponding to a significantly large clusters the likelihood of selecting an object rather than noise increases. Said additional selection is done as follows. A small volume (e.g. box or sphere) in of a pre-determined size is defined surrounding the depth pixel in the XYD space, and the amount of depth pixels that reside inside the volume is counted. The depth pixel is not selected if the counted amount is below a predetermined amount. In other words, if the pixel density at the depth pixel is too low then the depth pixel is not selected.

Optionally, the selection function SELFUN uses an automated process for determining objects A and B without using boundaries in XYD space retrieved from metadata. The automated process uses a clustering algorithm to determine groups of depth pixels forming large clusters in the XYD space. A group of depth pixels that form a cluster have, by definition, a similar position in the XYD space. From FIGS. 2a and 2b, it is apparent that object A and object B form separate clusters of depth pixels, which can be determined by a clustering algorithm. Having determined a large cluster in XYD space, the selection function SELFUN selects the depth pixels corresponding to an object by selecting the depth pixels that belong to that determined cluster. Note that the term ‘large cluster’ is used here to distinguish from the term ‘small cluster’ in the previous paragraph. A large cluster refers to an object, whereas a small cluster refers to spurious depth pixels, e.g. from noise.

The clustering algorithm used in the selection function may be a text-book clustering algorithm, such as the so-called K-means clustering algorithm (e.g. J. A. Hartigan (1975), ‘Clustering algorithms’, John Wiley & Sons, Inc.). Other commonly known clustering algorithms for searching clusters in a multi-dimensional space may also be used.

In addition to said similar position, the clustering technique may also determine a cluster using additional properties, such as similarity in color or structure. The color or structure associated to a depth pixel at a location in the depth map is retrieved from a corresponding location in the (content) image. For example, if object A corresponds to a smooth red ball then depth pixels of object A will not only be confined to a limited XYD space in the depth map, but the corresponding pixels in the content image will also be red and be part of a smooth region. (Note that by using two-dimensional location, depth, color and structure, the clustering algorithm effectively searches clusters in a five-dimensional space). Using the additional properties improves the accuracy and robustness of the clustering algorithm.

Note that the previous embodiment using an automated process for selecting depth pixels is consistent with previous embodiments, in the sense that depth pixels are selected using selection criteria based on location and depth value. Clusters of depth pixels are determined in the XYD space or location-depth space', and are thus based on location and depth value. Depth pixels are selected if they meet the criterion of belonging to the determined cluster in the XYD space.

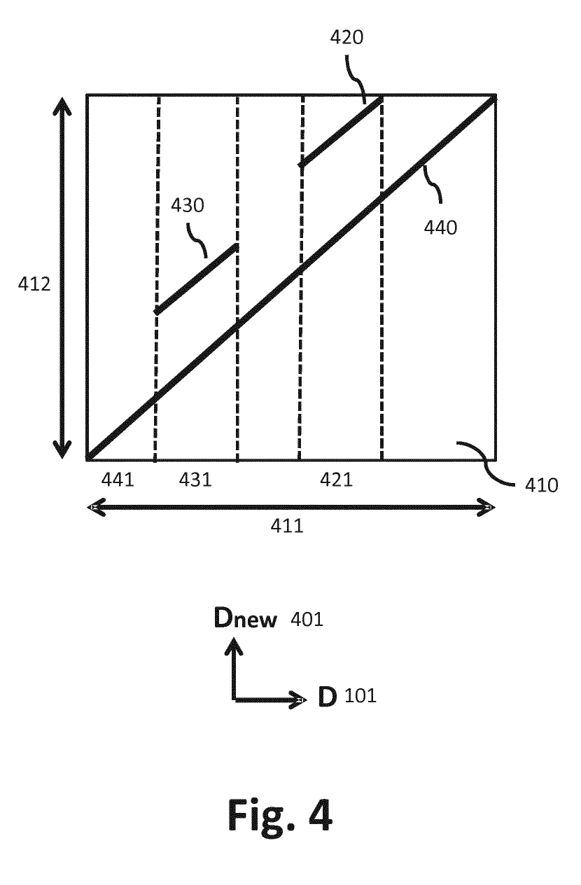

FIG. 4 illustrates a global remapping function 440 and two local remapping functions 420 and 430. Graph 410 has a input depth value D 101 on the horizontal axis and output depth value Dnew 401 on the vertical axis. The remapping functions 420-440 map the input depth value D from an input depth range 411 to the output depth range 412, which results in a new depth value Dnew. The output range 412 may correspond to a depth range of a 3D autostereoscopic display on which the 3D image is viewed. The remapping functions 420, 430, and 440 correspond to the above mentioned foreground objects A and B and the background C, respectively (see also FIGS. 2a/b). Respective depth ranges 421 and 431 include the depth values of the respective objects A an B. Depth values of background C are included by depth range 441.

The global remapping function 440 maps the background C from the input depth range 411 onto the lower end of the output depth range 412. In contrast, local remapping function 420 maps object A to the far upper end of the output depth range 412. Local remapping function 430 maps foreground object B to an intermediate part of the output depth range 412. The local remapping functions 420 and 430 are applied to the accurately selected depth pixels that corresponded to object A and B, respectively. The global remapping function 440 is applied to accurately selected depth pixels that correspond to background C, which are all depth pixels in depth map 210 excluding the selected depth pixels of objects A and B.

Determining function DETFUN may determine the local remapping functions 420 and 430 by retrieving data in the form of remapping parameters from metadata coupled to the 3D image. The remapping parameters define the local remapping functions 420 and 430. For example, remapping parameters that define the local remapping function 420 are the depth range 421 and the slope of the straight line 420.

Various types of curves may represent a local or global remapping function. The curve may be linear, as shown in FIG. 4. Other types include a piece-wise linear curve or a non-linear curve, each curve type defined by its own appropriate parameters.

The remapping functions 420-430 may be created in an artistic off-line process by video editing experts who design the remapping functions such that the depth perception is aesthetically pleasing when viewing the 3D image on a 3D display.

Alternatively, the remapping functions are determined by an automated process that is performed by the determining function DETFUN running on the (processing unit 199 of) image processing device 100. The automated process for determining the local remapping functions 420 and 430 may work according to an algorithm that increases a depth contrast between object A, object B and background C. Having received selected depth pixels from the preceding selection function SELFUN (the selected depth pixel corresponding to objects A and B and background C, the algorithm assesses the depth ranges that include objects A and B and background C, respectively. As a result, the algorithm determines that object A, object B and background C are included in depth ranges 421, 431 and 441, respectively. Next, the algorithm maps the depth ranges 421, 431 and 441 onto the output depth range 412, by using the full output depth range 412 while creating maximum depth contrast between object A, object B and background C. To that end, object A is remapped to the upper end of the output range 412, and object B is remapped to an intermediate range in between (a) the lower part of the output range 412 that includes the remapped background C and (b) the upper part of the output range 412 that includes the remapped object A. In this example, the slope of the remapping curves 420, 430 and 440 is maintained the same.

Depth contrast between, for example, object A and background C be quantified as follows.

Before remapping, depth values (of depth pixels) corresponding to object A are in depth range 421. The depth pixels of object A have depth values that are, on average, at approximately 0.7 (70%) of the input depth range 411. Likewise, depth values corresponding to background C in depth range 441, thus are on average at approximately 0.1 (10%) of the depth range 411. Consequently, the depth contrast between object A and background C before remapping is 0.7-0.1=0.6.

After remapping the situation is as follows. Depth values of object A are remapped by local remapping function 420 to output depth range 412: new depth values of object A are, on average, at approximately 0.9 (90%) of the output depth range 412. Likewise, new depth values of background C (remapped using local remapping function 440) are, on average, at approximately 0.1 (10%) of the output depth range 412. Consequently the depth contrast between object A and background C after remapping is 0.9-0.1=0.8. The depth contrast between object A and background C has thus increased from 0.6 to 0.8, as a result of the remapping

A similar quantification holds for a depth contrast between object B and background C and for a depth contrast between object B and object A. One can infer from FIG. 4 that the both these depth contrasts have also increased as a result of remapping.

As a variant to the previous embodiment, the automated process (performed by the determining function) determines a local remapping function for remapping object A such that the depth contrast between object A and background C increases by a fixed factor, for example by 0.15. The depth contrast after remapping then becomes 1.15×0.6=0.69. As mentioned above, new depth values of background C are at about 0.1 of the output depth range 412. The local remapping function 420 then needs to be shifted vertically in FIG. 4 such that, on average, the new depth values of object A are at about 0.1+0.69=0.79 of the output depth range 412.

Optionally, the global remapping function is also determined by the automated process. For example, in the case that depth pixels corresponding to the background have depth values in not only input depth range 441 but also in depth range 431 (i.e. the depth range of object B), the global remapping function 440 may be adapted such that it has a lower slope than indicated in FIG. 4, such that the depth values of background C are remapped to the lower end of output range 412, well below the remapped depth values of object B. As in the previous paragraph, determining the global remapping function may be based on increasing the depth contrast, in this case between background C and object B.

Note that, in the context of the current invention, ‘remapping an object’ refers to ‘remapping the depth values of the depth pixels corresponding to the object’. Likewise, ‘remapping the depth pixels’ refers to ‘remapping the depth values of the depth pixels.’.

An application of the image processing device 100 is remapping of the depth map in order to prepare the 3D image for being viewed on a 3D display. The 3D display is, for example, a multi-view autostereoscopic display. The 3D display typically has a limited disparity range. Depth and disparity are similar in a qualitative sense.

Disparity is defined as follows: a large disparity corresponds to an object appearing near a viewer, and a small disparity corresponds to an object appearing—far away from the viewer (zero disparity corresponds to infinitely far away). Thus, when shown on the 3D display, an object appearing in front of the plane of the display corresponds to large disparity values, and an object appearing behind the plane of the 3D display corresponds to small disparity values. The plane of the 3D display corresponds to a specific disparity value, which will be referred to as the ‘display disparity value’ below.

For rendering the 3D image on the 3D display, the depth map needs to be converted to disparity. The conversion is based on some definitions between depth and disparity. The definitions concern zero depth, minimum- and maximum depth, and the position of a viewer relative to the plane of the 3D display. A common choice is to define zero depth as corresponding to the plane of the 3D display, so that a positive depth value corresponds to a position in front of the plane of the 3D display and a negative depth value corresponds to a position behind the plane of the 3D display. The relation between depth and disparity is further defined by choosing a maximum and minimum disparity that corresponds to the minimum- and maximum disparity, respectively. A common definition for the position of the viewer relative to the plane of the 3D display is a typical viewer position (for example, the viewer being in a living room and watching his 3D display having a 55″ diagonal is typically at 3-to-4 meters in front of the 3D display. Finally, depth is then converted to disparity based on a curve defined by the definitions in this paragraph.

When the 3D image is to be rendered for viewing on a 3D display, the depth map thus needs to be converted to a disparity map, using a curve as described in the previous paragraph. This depth-to-disparity conversion may be combined with remapping a depth map according to three scenarios: (1) the depth map is remapped, and the remapped depth map is then converted to a disparity map, or (2) the curves for the depth remapping and for depth-to-disparity conversion are integrated in to a single curve, or (3) the depth map is converted to a disparity map, and the disparity map is subsequently remapped according to a disparity remapping curve. The disparity remapping curve may be derived by applying the depth-to-disparity conversion to the depth remapping curve itself.

When the 3D display has a limited disparity range, an object may appear ‘flattened’ in the depth direction when shown on the 3D display. This occurs when a relatively large depth range is mapped to a relatively small disparity range. For example, a ball defined as a perfectly round ball in the location-depth space would then appear on the 3D display as a ball squashed in the depth direction, becoming an ellipsoid rather than a sphere. The local remapping function used to remap the depth values of the ball may be defined to compensate for the flattening. For example, the object A in FIGS. 2a/2b corresponds to the ball, and the local remapping 420 curve of FIG. 4 is for remapping the depth values of the ball: compensating for the flattening in the depth direction is accomplished by increasing the slope of the local remapping function 420.

As an example, object B corresponds to a logo in the content image. For the purpose of legibility, object B is to be remapped such that it is viewed in the plane of the 3D display. To that end, the determining function determines the local remapping function 430 such that object B is remapped to depth values near zero (corresponding, in this case, to the plane of the 3D display). The latter is actually the case in FIG. 4 if the center of the output depth range 412 corresponds to zero depth. Alternatively, object B corresponds to a logo that is to be viewed in front of the 3D display, in which case the local remapping function 430 is determined such that object B is remapped to the upper part of output range 412.

The global remapping function may be established in different ways. Optionally, the processing unit 199 applies a pre-determined global remapping function. Optionally, the global remapping function is included in metadata coupled to the 3D image. Optionally, both the global remapping function and the local remapping functions are included in metadata coupled to the 3D image.

Optionally, the image processing device 100 receives the 3D image from an image encoding device via a network link The image encoding device sends a signal comprising the 3D image to the image processing device 100. Optionally, the signal further comprises metadata containing selection criteria for selecting, for example, object A in the 3D image. The metadata is thus coupled to the 3D image. For example, the metadata comprises a 3D bounding box (i.e. in XYD-space) for selecting object A. Optionally, the signal further comprises the local remapping function 420 for remapping the depth pixels corresponding to object A. Note that the image processing device 100 effectively acts as an image decoding device by receiving and using the signal from the image encoding device.

Optionally, the signal sent by the image encoding device comprises a 3D video sequence, i.e. a 3D movie. The 3D video sequence comprises (3D) video frames, wherein each video frame comprises a 3D image. Optionally, the signal comprises, for each 3D image (thus each video frame), metadata coupled to the 3D image, in a similar way as described in the previous paragraph.

Optionally, the signal comprises the metadata only once every N video frames, wherein N=12 for example. Similar as above, the metadata may comprise a 3D bounding box for selecting object A. However, object A is generally not static but may move throughout the 3D video sequence, i.e. the location of object A changes. In order to select and remap object A for each video frame, a 3D bounding box is needed for each video frame. To obtain a 3D bounding box for each video frame, (the processing unit 199 of) the image processing device 100 tracks object A by using motion vectors that describe the movement of object A the video frames or between every N video frames. Knowing the location of the 3D bounding box at the first of the N video frames, the bounding box for the next frames is obtained by moving (the location of) the bounding box according to the motion vectors. Optionally, the motion vectors are also included in the signal comprising the 3D video sequence. Optionally, the motion vectors are obtained by applying a motion estimator to the video sequence. Optionally, the motion vectors indicate 3D-motion in the XYD-space, thus in the terms of location as well as in the depth dimension.

As an alternative to using motion vectors, the processing unit 199 may apply alpha blending between two subsequent bounding boxes to obtain a bounding box at each video frame. This works as follows. The processing unit 199 first retrieves from the signal two subsequent 3D bounding boxes from the 3D video sequence: one bounding box corresponding to video frame 1 and the second bounding box corresponding to video frame N+1. Both 3D bounding boxes correspond to the same object, but at different video frames. If a specific corner of the 3D bounding boxes

has coordinate R₁=(X₁,Y₁,D₁) at frame 1 and

has coordinate R_{N+1}=(X_{N+1},Y_{N+1},D_{N+1}) at frame N+1, it then

has coordinate Rₖ=αR₁+(1−α) R_{N+1} at an intermediate frame k,

where α=(N+1−k)/N and 1<k<N+1. Note that the coordinates are in the three-dimensional XYD space. The same alpha blending needs to be applied to other corners of the 3D bounding box in order to obtain the coordinates of all corners of the 3D bounding box at frame k. Note that the coordinates of the 3D bounding box are thus effectively interpolated between frames.

Analogously, the processing unit 199 may also use alpha blending to obtain a global remapping function at the intermediate frame k. For example, if the global remapping function

at frame 1 is G₁(D), and

at frame N+1 is G_{N+1}(D), then

at frame k it is Gₖ(D)=G₁(D)+(1−α) G_{N+1}(D),

where α and k are as above, and variable D represents depth. An analogous procedure may obviously be applied to interpolate a local remapping function.

Note that the previous embodiments use a bounding box for selecting objects. Other shapes or combinations of shapes may also be used for selecting objects, as mentioned above in this description.

Optionally, in the case (above) of the signal comprising a 3D video sequence, the signal includes for each video frame (or for each N video frames) multiple bounding boxes for selecting respective multiple objects, respective multiple local remapping functions, and a global remapping function.

Optionally, the image encoding device applies a video compression technique to encode the 3D video sequence. The compression technique may be based on H.264, H.265, MPEG-2 or MPEG-4, for example. The encoded 3D video sequence may be configured in so-called GOP-structures (Group Of Pictures). Each GOP structure includes boundaries for selecting foreground objects and local and global remapping functions for remapping the foreground objects and the background, respectively. The image processing device 100 (in particular its processing unit 199) is arranged to receive and decode the encoded 3D video sequence and retrieve the 3D image, the boundaries and the local/global remapping functions.

Optionally, the image encoding device composes the signal by generating metadata for a given three-dimensional image. For example, the boundaries for selecting an object at a decoder side (e.g. the image processing device 100) are determined by the image encoding device by (a) automatically determining a foreground object and (b) fitting a shape like a bounding box or an ellipsoid around the determined object. Automatically determining the foreground object (and selecting the corresponding depth pixels) may be done using an embodiment described above, wherein an automated process using a clustering algorithm determines a foreground object. Fitting, for example, a bounding box around the selected depth pixels may be done by determining the ranges of the selected depth pixels (in X, Y and D dimension) and fitting the bounding box based on the ranges.

Optionally, the image encoding device generates metadata including a local and/or global remapping function. The local/global remapping function may be the automated process described above, based on increasing the depth contrast between foreground object(s) and a background.

Combining the previous two paragraphs, the image encoding device may thus automatically determine a boundaries for selecting foreground objects and the background, determine automatically the local/global remapping functions, include the determined boundaries and the determined local/global remapping functions in the metadata, and include the metadata in the signal.

Alternatively, the image encoding device composes the signal by wrapping the given three-dimensional image and corresponding given metadata together in the signal.

A image processing method is disclosed in analogy to the image processing device 100. The image processing method performs the selecting, the determining and the remapping in the same manner as performed by the selection function, the determining function and the remapping function of the image processing device 100, respectively.

Furthermore, an image encoding method is disclosed in analogy to the image encoding device as described above: the image encoding method performs the steps of the image encoding device for generating the signal, in particular the metadata.

This image processing method and/or image encoding method may be used in the form of a computer program that instructs a processor to perform the steps of the respective method. The computer program may be stored on a data carrier, such as a DVD, CD, or a USB-stick. The computer program product may run on a personal computer, a notebook, (as an app on) a smartphone, or on an authoring system

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An image processing device arranged for remapping a depth map of a three-dimensional image, the image processing device comprising:
wherein the three-dimensional image comprises the depth map and a two-dimensional content image,
wherein the depth map has depth pixels configured in a two-dimensional array at locations corresponding to locations of image pixels in the content image,
wherein each of the depth pixels has a depth value,
wherein the remapping comprises a global remapping function arranged to map of the depth values of the depth map to new depth values,
a receiving unit arranged to receive a signal comprising the three-dimensional image and metadata coupled to the three-dimensional image,
wherein the metadata comprises selection criteria based on at least the location and the depth value for selecting selected depth pixels corresponding to at least one object in the three-dimensional image, and
a processing unit the processing unit comprising
a selection function arranged to retrieve, from the metadata, the selection criteria and the selected depth pixels, wherein the selected depth pixels correspond to at least one object in the three-dimensional image using the selection criteria;
a determining function arranged to determine a local remapping function, wherein the local remapping function maps the depth values of the selected depth pixels to the new depth values; and
a mapping function arranged to remap the depth map using the local remapping function for remapping the selected depth pixels and using the global remapping function for depth pixels other than the selected depth pixels.

2. The image processing device of claim 1, wherein the processing unit is arranged for retrieving, from the metadata, data for determining the local remapping function.

3. The image processing device of claim 1, wherein the selection criteria comprise boundaries in the location and the depth value and the selection function is configured for selecting the depth pixels lying within said boundaries.

4. The image processing device of claim 3, wherein the boundaries define a three-dimensional closed volume having a first dimension corresponding to the depth value, and a second dimension and a third dimension at a corresponding location.

5. The image processing device of claim 4, wherein the three-dimensional closed volume is formed by a plurality of volumes, wherein the shape is chosen from the group consisting of a box, an ellipsoid, a sphere, a cube, and a parallelepiped.

6. The image processing device of claim 3,
wherein the boundaries are defined by a bounding box,
wherein the bounding box has at least two dimensions,
wherein the first of the two dimensions corresponds to the depth value and the second of the two dimensions corresponds to the location.

7. The image processing device of claim 3, wherein the three-dimensional image corresponds to a video frame of a three-dimensional video and the selecting function is configured for determining a locations of said boundaries by extrapolating from locations of other boundaries corresponding to another video frame of the three-dimensional video, using motion vectors.

8. The image Image processing device of claim 1,
wherein the selection function is configured for selecting depth pixels using as a further selection criterion,
wherein the further selection criterion uses a volume of a predetermined size surrounding each of the selected depth pixels such that the volume of predetermined size contains an amount of depth pixels that exceeds a predetermined amount.

9. The image processing device of claim 1,
wherein the selection function is configured for selecting the depth pixels using as a further selection criterion,
wherein the further selection criterion determines that the selected depth pixels form a cluster in the location and the depth value.

10. The image processing device of claim 1,
wherein the determining function is configured for determining the local remapping function such that the remapping the depth map according to the local remapping function increases a depth contrast between the selected depth pixels corresponding to the at least one object and other depth pixels in the depth map,
wherein the depth contrast is the difference between an average of the depth values of the selected depth pixels and an average of the depth values of the other depth pixels relative to a depth range,
wherein the depth range is an input depth range before the mapping and an output depth range after the remapping.

11. The image processing device of claim 1,
wherein the three-dimensional image comprises the remapped depth map for viewing on a three-dimensional display,
wherein the determining function is configured for determining the local remapping function for mapping the depth values of the selected depth pixels to the new depth values,
wherein the new depth value correspond to respective new disparity values being in a pre-determined disparity range of the three-dimensional display.

12. (canceled)

13. A method of remapping a depth map of a three-dimensional image, wherein the three-dimensional image comprises the depth map and a two-dimensional content image, wherein the depth map has depth pixels configured in a two-dimensional array at locations corresponding to locations of image pixels in the content image, wherein each of the depth pixels having a depth value, wherein the remapping comprising a global remapping function for mapping depth values of the depth map to new depth values, the method comprising:
receiving a signal comprising the three-dimensional image and metadata coupled to the three-dimensional image, wherein the metadata comprises selection criteria based on at least the location and the depth value, wherein the selected depth pixels correspond to at least one object in the three-dimensional image,
retrieving, from the metadata, the selection criteria,
selecting depth pixels corresponding to the at least one object in the three-dimensional image using the selection criteria;
determining a local remapping function for mapping the depth values of the selected depth pixels to the new depth values; and
remapping the depth map using the local remapping function for remapping the selected depth pixels and using the global remapping function for the depth pixels other than the selected depth pixels.

14. (canceled)

15. A computer program product comprising instructions for causing a processor to perform the selecting, determining and remapping according to the method of claim 13.
